(19) United States
(12) Patent Application Publication
(10) Pub. No.: US 2025/0050662 A1
(43) Pub. Date: Feb. 13, 2025

(54) RECORDING DEVICE

(71) Applicant: SEIKO EPSON CORPORATION, Tokyo (JP)

(72) Inventors: Satoshi NAKATA, Matsumoto-Shi (JP); Masanari TANAKA, Shiojiri-Shi (JP); Yusuke KOMIYAMA, Matsumoto-Shi (JP); Katsumi MARUYAMA, Azumino-Shi (JP); Kanji MOMOSE, Matsumoto-Shi (JP)

(21) Appl. No.: 18/794,928

(22) Filed: Aug. 5, 2024

(30) Foreign Application Priority Data
Aug. 7, 2023 (JP) 2023-128356

(51) Int. Cl. B41J 11/70; B41J 2/17; B41J 29/02; B41J 29/17

(52) U.S. Cl. CPC B41J 11/706; B41J 2/1721; B41J 29/02; B41J 29/17

(57) ABSTRACT

A recording device includes: a recording unit configured to perform recording on a medium transported from upstream in a transport direction toward downstream; a cutting unit configured to cut the medium on which recording is performed by the recording unit; a discharging unit configured to transport, to the downstream in the transport direction, the medium on which recording is performed by the recording unit and the medium cut by the cutting unit; and a removing unit configured to remove paper dust generated when the medium is cut by the cutting unit.

The present application is based on and claims priority from JP Application Serial Number 2023-128356, filed Aug. 7, 2023, the disclosure of which is hereby incorporated by reference herein in its entirety.

### BACKGROUND

### 1. Technical Field

The present disclosure relates to a recording device.

### 2. Related Art

JP-A-2023-050218 discloses a printing apparatus serving as one example of a recording device and including, within a housing, a printing unit and a cutting unit. It is disclosed that the printing unit serving as one example of a recording unit includes an ink jet type recording head, and the recording head is used to print an image on a printing sheet serving as one example of a medium. In addition, it is also disclosed that, with a cutting blade, the cutting unit cuts the printing sheet into an upstream portion and a downstream portion of the printing sheet in the transport direction.

However, in a case of the printing apparatus disclosed in JP-A-2023-050218, there is a possibility that a paper dust generated at the time of cutting the printing sheet with the cutting unit causes a trouble of operation of the printing apparatus.

### SUMMARY

A recording device includes a recording unit configured to perform recording on a medium transported from upstream in a transport direction toward downstream, a cutting unit configured to cut the medium on which recording is performed by the recording unit, a discharging unit configured to transport, to the downstream, the medium on which recording is performed by the recording unit and the medium cut by the cutting unit, and a removing unit configured to remove paper dust generated when the medium is cut by the cutting unit.

A recording device includes a recording unit configured to perform recording on a medium transported from upstream in a transport direction toward downstream, a cutting unit configured to cut the medium on which recording is performed by the recording unit, a discharging unit configured to transport, to the downstream, the medium on which recording is performed by the recording unit and the medium cut by the cutting unit, and a paper-dust holding unit disposed below the cutting unit and configured to hold paper dust generated when the medium is cut by the cutting unit.

### BRIEF DESCRIPTION OF THE DRAWINGS

FIG. 1 is a perspective view of an embodiment of a recording device.

FIG. 2 is a schematic top view of the main components of an apparatus body of the recording device.

FIG. 3 is a schematic side diagram of the main components of the recording device.

FIG. 4 is a perspective view of a cutting unit.

FIG. 5 is an enlarged view of a portion D5 illustrated in FIG. 2.

FIG. 6 is a schematic side diagram of the main components of the cutting unit.

FIG. 7 is a schematic cross-sectional view taken along the S7-S7 cross-section illustrated in FIG. 6.

FIG. 8 is a schematic cross-sectional view taken along the S8-S8 cross-section illustrated in FIG. 6.

FIG. 9 is a perspective view illustrating a state in which a medium is cut by the cutting unit.

### DESCRIPTION OF EMBODIMENTS

Below, the present disclosure will be described on the basis of embodiment. In each drawing, the same reference characters are attached to the same members, and explanation thereof will not be repeated. Note that, in the present description, the terms “same”, “identical”, and “simultaneously” do not only mean complete sameness. For example, the terms “same”, “identical”, and “simultaneously” in the present description include a case of being the same with measurement errors being taken into consideration. In addition, for example, the terms “same”, “identical”, and “simultaneously” in the present description include a case of being the same with manufacturing variations of members being taken into consideration. Furthermore, for example, the terms “same”, “identical”, and “simultaneously” in the present description include a case of being the same as long as functions are impaired. Thus, for example, the expression “both dimensions are the same” means that a dimensional difference between the two dimensions is within ±5% of either of the dimensions, and may be particularly preferably within ±3% in consideration of measurement errors and manufacturing variations of members.

### 1. First Embodiment

A recording device 11 is, for example, an ink-jet type printer configured to perform recording on a printing sheet, an envelope, or the like in a form of sheet serving as one example of a medium P.

Note that the “X”, “Y”, and “Z” in each drawing represent three spatial axes orthogonal to each other. In the present description, directions along these axes are an X-axis direction, a Y-axis direction, and a Z-axis direction. When an orientation is specified, description will be made such that positive and negative signs are used for direction notation with “+” for a positive direction and “−” for a negative direction, and an orientation where an arrow in each drawing is directed is a + direction and an opposite direction to the arrow is a − direction.

In addition, the Z-axis direction indicates the gravitational direction, where the +Z direction indicates a vertically downward direction, and a −Z direction indicates a vertically upward direction. Furthermore, a plane including the X-axis and the Y-axis is described as an X-Y plane. A plane including the X-axis and the Z-axis is described as an X-Z plane. A plane including the Y-axis and the Z-axis is described as a Y-Z plane. In addition, the X-Y plane corresponds to a horizontal plane. Furthermore, the three spatial axes of X, Y, and Z that are not limited to the positive and negative directions will be described as the X-axis, Y-axis, and Z-axis.

The X-axis direction is a direction intersecting the transport direction of a medium P in an apparatus body 12, that is, serves as one example of the width direction of the medium P, and also serves as one example of the width direction of the recording device 11 and the apparatus body 12. In addition, the X-axis direction is a horizontal direction along a mounting surface MS that is the horizontal surface on which the recording device 11 is mounted. Furthermore, the +X direction is the left side and the −X direction is the right side as viewed from an operator located at the front face side of the recording device 11. Note that the front face of the recording device 11 and the apparatus body 12 in the present embodiment is a surface where an operation unit 14 is provided.

The Y-axis direction is a depth direction of the recording device 11 and the apparatus body 12. In addition, the Y-axis direction is a horizontal direction along the mounting surface MS that is the horizontal surface on which the recording device 11 is mounted. Of the Y-axis direction, the +Y direction is a direction from the back surface of the recording device 11 and the apparatus body 12 toward the front face of the recording device 11 and the apparatus body 12, and the −Y direction is a direction from the front face of the recording device 11 and the apparatus body 12 toward the back surface of the recording device 11 and the apparatus body 12.

The Z-axis direction is a normal-line direction with respect to the mounting surface MS, and is the height direction of the recording device 11 and the apparatus body 12. In the following description, the +Z direction is also referred to as a “downward side”, and −Z direction is also referred to as an “upward side”.

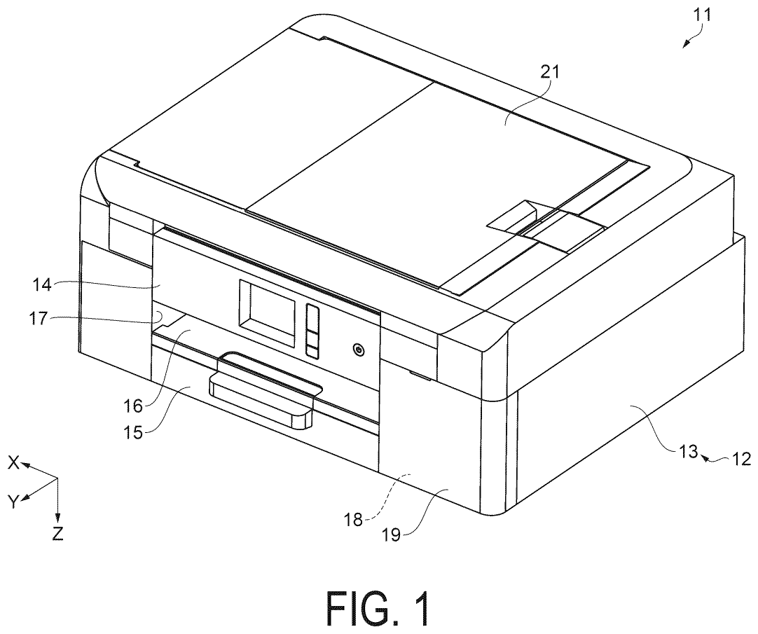

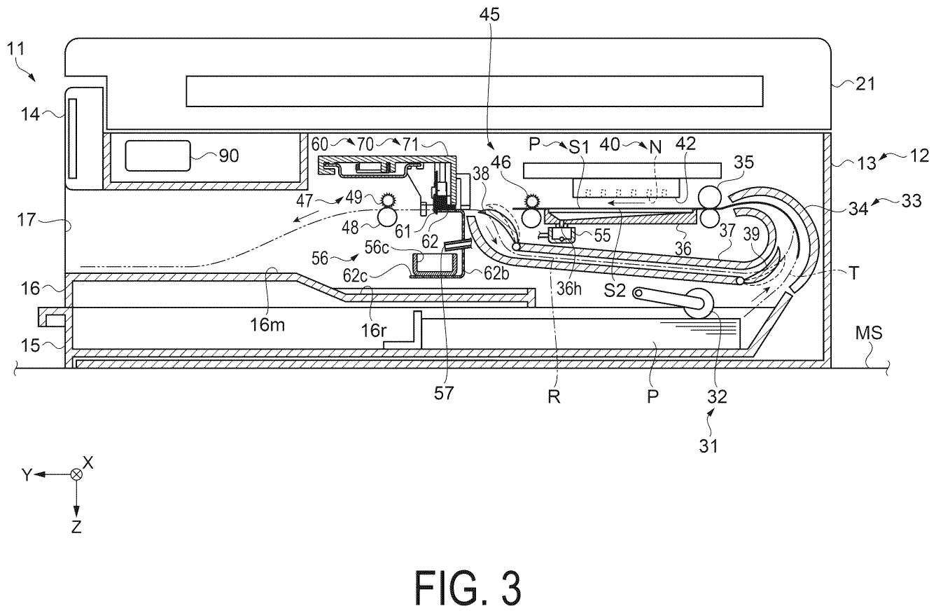

As illustrated in FIGS. 1 and 3, the recording device 11 includes the apparatus body 12 and a reading unit 21.

The reading unit 21 reads an image of an original document. The reading unit 21 is provided at an upper side serving as the −Z direction side of the apparatus body 12 in the Z-axis direction.

The apparatus body 12 includes a housing 13, the operation unit 14, an accommodation unit 15, and a mounting section 16. Note that, in each of the drawings, a transport path T through which the medium P is transported is indicated with the long dashed double-short dashed line, and an inversion path R is indicated with the long dashed short dashed line.

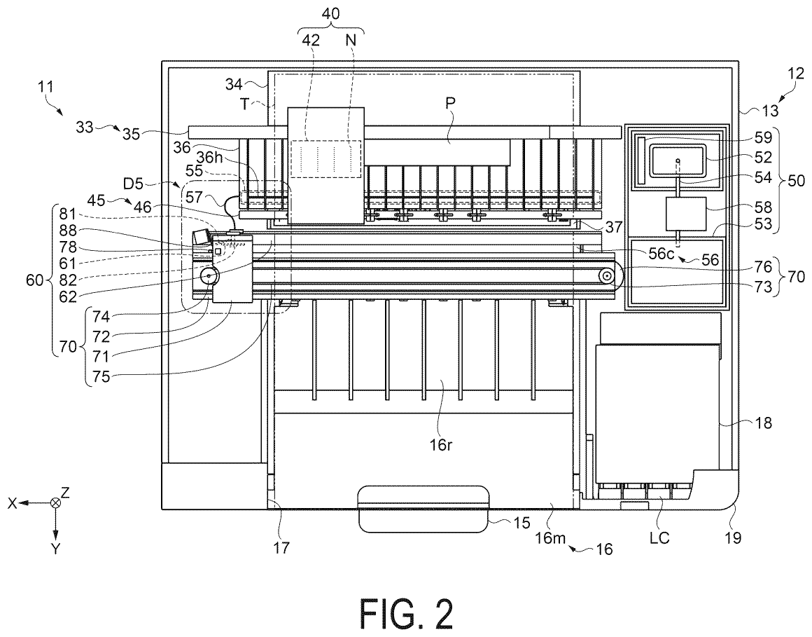

The housing 13 is provided with the operation unit 14 at the center, in the X-axis direction, of the front face that is a surface at the +Y direction side. In addition, the housing 13 is provided with an opening 17 at the center of the front face in the X-axis direction and at a position at the +Z direction side of the operation unit 14. Furthermore, the housing 13 includes, within the housing 13, a feeding unit 31, a transport unit 33, a recording unit 40, a liquid-accommodating-body holding unit 18, a cutting unit 60, a discharging unit 45, and a control unit 90. In addition, as illustrated in FIG. 2, the housing 13 includes, within the housing 13, a maintenance unit 50.

As illustrated in FIG. 1, the operation unit 14 includes a touch panel type display unit, an operation button, and the like, and displays a message on the display unit to notify a user of it.

The accommodation unit 15 is able to accommodate a plurality of media P in a folded state. The accommodation unit 15 is a so-called tray having a shape of closed-bottom box of which −Z direction side is opened so as to be able to mount the medium P. As the tip side, which is the −Y direction side, of the accommodation unit 15 is inserted into the inside of the housing 13 through the opening 17, the accommodation unit 15 is disposed at a supply position (see FIG. 3) at which the accommodated medium P is fed into the transport path T. In other words, the accommodation unit 15 is provided within the housing 13 so as to be detachable.

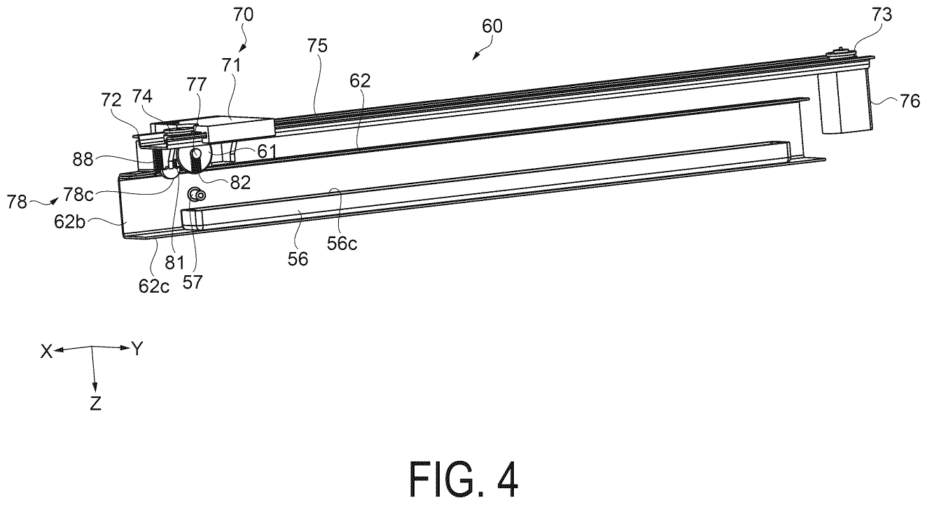

As illustrated in FIG. 3, at the supply position, the accommodation unit 15 is disposed at the +Z direction side that is the vertically downward side of the operation unit 14. In addition, at the supply position, the accommodation unit 15 is disposed at the +Z direction side that is the downward side of the cutting unit 60 and removing units 81 and 82 (see FIGS. 2 and 4) that will be described later. In other words, at the supply position, the accommodation unit 15 overlaps with the movement region of the cutting unit 60 and the removing units 81 and 82 as viewed from the vertically upward side that is the −Z direction side. When detached from the housing 13, the accommodation unit 15 is configured such that the medium P can be set in the accommodation unit 15.

The feeding unit 31 includes a feeding roller 32. The feeding roller 32 rotates in a state of coming into contact with the medium P accommodated in the accommodation unit 15, thereby sending the medium P located at the uppermost side to the transport path T. The feeding unit 31 sends the medium P accommodated in the accommodation unit 15 one by one to the transport path T. Note that, in the following description, the transport direction (see the arrow in FIG. 3) in which the medium P is transported along the transport path T, a direction in which the medium P is being sent is also referred to as “downstream”, and the direction opposite from this direction is also referred to as “upstream”.

The medium P sent by the feeding unit 31 to the transport path T is transported along the curved portion of the transport path T. With this configuration, the medium P is transported along the transport path T toward a transport roller pair 35 disposed downstream in the transport direction while changing the direction in which the medium is transported.

The transport unit 33 transports the medium P along the transport path T from upstream in the transport direction toward downstream. The transport unit 33 includes a transport path member 34, the transport roller pair 35, a medium support portion 36, an inversion path member 37, and switching units 38 and 39.

Of the transport path T, the transport path member 34 constitutes a curved transport path between the accommodation unit 15 and the transport roller pair 35.

In the transport path T, the transport roller pair 35 is provided at a position between the transport path member 34 and the medium support portion 36. By rotating in a state in which the medium P is interposed in the transport roller pair 35, the transport roller pair 35 transports the medium P along the transport path T toward the medium support portion 36 disposed at the +Y direction side of the transport roller pair 35.

Of the transport path T, the Y-axis direction serves as one example of the transport direction in the transport path through which the medium P that has passed through the transport roller pair 35 is transported. In addition, of the transport path T, a transport path through which the medium P that has passed through the transport roller pair 35 is transported is configured such that the −Y direction serves as one example of the upstream in the transport direction, and the +Y direction serves as one example of the downstream in the transport direction.

In the transport path T, the medium support portion 36 is disposed at the +Y direction side of the transport roller pair 35. The medium support portion 36 is disposed at the −Z direction side of the accommodation unit 15 and the feeding unit 31. The medium support portion 36 is disposed at the −Z direction side with respect to an upstream end, in the transport direction, of the transport path T that the transport path member 34 constitutes. The medium support portion 36 supports at least a portion of the medium P on which recording is performed by the recording unit 40.

As illustrated in FIGS. 2 and 3, the medium support portion 36 is provided with a guiding-out section 36h configured to lead out, from the medium support portion 36, ink ejected to a region of the medium support portion 36 that lies outside of the medium P when recording is performed by the recording unit 40. For example, the guiding-out section 36h includes a plurality of through-holes that penetrate through the medium support portion 36 in the Z-axis direction.

The ink ejected to a region of the medium support portion 36 that lies outside of the medium P is collected, through the guiding-out section 36h, as a waste liquid, to a waste-liquid collection section 55 provided at the +Z direction side of the medium support portion 36. In addition, the ink collected to the waste-liquid collection section 55 as a waste liquid flows through a flow-in section 57 into a paper-dust holding unit 56 that will be described later. With this operation, the paper-dust holding unit 56 and paper dust within the paper-dust holding unit 56 get wet, which makes it possible to suppress spreading of the paper dust from the paper-dust holding unit 56. The flow-in section 57 is, for example, a tube having flexibility.

The inversion path member 37 constitutes the inversion path R that makes it possible to transport the medium P transported in the +Y direction of the medium support portion 36, to the upstream end, in the transport direction, of the transport path T that the transport path member 34 constitutes. The inversion path member 37 extends in the X-axis direction and across the width size of the medium P. In addition, the inversion path member 37 passes through the medium support portion 36 and the +Z direction side of the waste-liquid collection section 55, and extends in the Y-axis direction.

The end, at the +Y direction side, of the inversion path member 37 is disposed in the Y-axis direction between a side wall 62b of the cutting unit 60 and a first discharging roller pair 46 that will be described later. In the Z-axis direction, an end, at the +Y direction side, of the inversion path member 37 is disposed at the +Z direction of the upper surface of a fixed blade 62, which will be described later, of the cutting unit 60 or equal to the upper surface of the fixed blade 62. The upper surface of the fixed blade 62 is a surface, at the −Z direction side, of the fixed blade 62. In addition, in the Z-axis direction, an end, at the +Y direction side, of the inversion path member 37 is disposed at the −Z direction of the paper-dust holding unit 56.

An end, at the −Y direction side, of the inversion path member 37 is coupled to an upstream end, in the transport direction, of the transport path member 34. In the Y-axis direction, the end, at the −Y direction side, of the inversion path member 37 is disposed more toward the −Y direction side than the medium support portion 36. The end, at the −Y direction side, of the inversion path member 37 is disposed more toward the +Z direction side than the end, in the +Y direction side, of the inversion path member 37. In the Z-axis direction, the end, at the −Y direction side, of the inversion path member 37 is disposed between the medium support portion 36 and the accommodation unit 15.

In addition, the end, at the +Y direction side, of the inversion path member 37 is disposed more toward the +Y direction side than an ejecting surface 42 of the recording unit 40. In addition, the end, at the −Y direction side, of the inversion path member 37 is disposed at the −Y direction side of the ejecting surface 42 of the recording unit 40. Thus, the inversion path member 37 serves as one example of a wall portion WP configured to make the paper-dust holding unit 56 and the ejecting surface 42 of the recording unit 40 separated in the Y-axis direction. In addition, the inversion path member 37 covers the direction of the paper-dust holding unit 56 toward the recording unit 40. Thus, the inversion path member 37 is configured to separate the paper-dust holding unit 56 from the recording unit 40.

The switching unit 38 and 39 changes their positions into a transport position illustrated in FIG. 3 with the solid line and an inverting position illustrated with the dashed line, thereby switching paths through which the medium P is transported. The switching unit 38 is provided at an end, at the +Y direction side, of the inversion path R so as to be able to rotate about the axial center along the X-axis. The switching unit 39 is provided at an end, at the −Y direction side, of the inversion path R so as to be able to rotate about the axial center along the X-axis.

When the switching units 38 and 39 are disposed at the transport position, it is possible to transport the medium P from the accommodation unit 15 along the transport path T toward the mounting section 16 (see the arrow in FIG. 3). When the switching units 38 and 39 are disposed at the inverting position, it is possible to transport the medium P along the inversion path R from the +Y direction side of the inversion path R toward the −Y direction side (see the arrow in FIG. 3).

The recording unit 40 includes a plurality nozzles N provided in the ejecting surface 42 and configured to eject a liquid. The ejecting surface 42 is disposed at the +Y direction side of the transport roller pair 35. The ejecting surface 42 is disposed so as to be opposed to the medium support portion 36 with the transport path T being interposed between them. The recording unit 40 is provided within the housing 13 so as to be able to move along the X-axis direction across the width size of the medium P.

The recording unit 40 ejects ink serving as one example of a liquid from the nozzles N while moving along the X-axis direction, thereby performing recording on a first surface S1 of the medium P supported by the medium support portion 36. Note that, in FIG. 3, the first surface S1 of the medium P is a surface opposed to the nozzles N, and is a surface opposite from a second surface S2 supported by the medium support portion 36.

As illustrated in FIGS. 1 and 2, within the housing 13, the liquid-accommodating-body holding unit 18 is provided at the −X direction side of the accommodation unit 15 such that a liquid accommodating body LC is detachable, and the liquid accommodating body LC is configured to accommodate ink to be ejected from the recording unit 40. By opening a holding unit cover 19 provided at the +Y direction side of the liquid-accommodating-body holding unit 18, the liquid accommodating body LC is detachable from the +Y direction with respect to the liquid-accommodating-body holding unit 18. The liquid-accommodating-body holding unit 18 is coupled to the recording unit 40 through a supply tube (not illustrated) such that ink from the liquid accommodating body LC attached to the liquid-accommodating-body holding unit 18 can be supplied to the recording unit 40.

The maintenance unit 50 performs maintenance of the recording unit 40. As illustrated in FIG. 2, within the housing 13, the maintenance unit 50 is disposed at the −X direction side of the transport path T and at the −Y direction side of the liquid-accommodating-body holding unit 18. The maintenance unit 50 includes a waste-liquid receiving section 52, a waste-liquid tank 53, a waste-liquid tube 54, a pump 58, and a wiper 59.

During maintenance of the recording unit 40, the waste-liquid receiving section 52 receives ink discharged from the recording unit 40 as a waste liquid. The waste-liquid receiving section 52 is disposed at the +Z direction side that is the vertically downward side of a scanning region in which the recording unit 40 moves along the X-axis direction. The waste-liquid receiving section 52 receives ink discharged from the recording unit 40 as a waste liquid in a state of being in contact with the ejecting surface 42 of the recording unit 40 or in a state of being away from the ejecting surface 42.

The ink that the waste-liquid receiving section 52 receives as a waste liquid is collected by the waste-liquid tank 53 through the waste-liquid tube 54. In the waste-liquid tube 54, there is provided the pump 58 configured to deliver, toward the waste-liquid tank 53, the waste liquid received by the waste-liquid receiving section 52. In the Y-axis direction, the waste-liquid tank 53 is provided at a position between the waste-liquid receiving section 52 and the liquid-accommodating-body holding unit 18. The wiper 59 is configured to wipe the ejecting surface 42 of the recording unit 40 to remove a foreign material such as ink or paper dust attached on the ejecting surface 42.

As illustrated in FIGS. 2 and 3, the cutting unit 60 is disposed at the +Y direction side of the recording unit 40 and the medium support portion 36 so as to be able to cut the medium P on which recording is performed by the recording unit 40. In addition, the cutting unit 60 includes the removing units 81 and 82 configured to remove paper dust generated when the medium P is cut by the cutting unit 60.

As illustrated from FIG. 2 to FIG. 4, the cutting unit 60 includes a movable blade 61, the fixed blade 62, and a moving unit 70. The moving unit 70 moves the movable blade 61 in the X-axis direction intersecting the Y-axis direction. The moving unit 70 includes a carriage 71, a carriage guide 72, pulleys 73 and 74, an endless belt 75, a carriage motor 76, and an encoder (not illustrated). The encoder is a rotary encoder configured to detect rotation of the carriage motor 76.

The carriage 71 is supported by the carriage guide 72 extending in the X-axis direction across the width size of the medium P so as to be able to move in the X-axis direction. The carriage 71 is attached at the endless belt 75 looped over the pulleys 73 and 74 disposed so as to be spaced apart from each other in the X-axis direction. The pulley 73 is fixed at a drive shaft of the carriage motor 76. The carriage motor 76 is driven on the basis of a signal that the rotary encoder detects, whereby the carriage 71 moves toward the +X direction or the −X direction along the X-axis direction.

The carriage 71 includes the movable blade 61, the removing units 81 and 82, and a contact portion 78. The movable blade 61 is provided at the carriage 71 so as to be able to cut the medium P. As illustrated from FIG. 4 to FIG. 8, the movable blade 61 is supported by a shaft portion 77 provided at the carriage 71. The shaft portion 77 has a cylindrical shape extending in the Y-axis direction. The movable blade 61 is supported by the shaft portion 77 so as to be rotatable with the shaft portion 77 being the center of rotation. In the present embodiment, the movable blade 61 is a so-called circular blade that is a blade having a circular shape. As the carriage 71 moves along the X-axis direction, the movable blade 61, the removing units 81 and 82, and the contact portion 78 move along the X-axis direction.

The fixed blade 62 is provided at the +Z direction side of the carriage 71. The fixed blade 62 extends in the X-axis direction so as to correspond to the movement region of the movable blade 61. In addition, the fixed blade 62 extends in the Y-axis direction, and the end, at the +Y direction, of the fixed blade 62 comes into contact with a surface, at the −Y direction side, of the movable blade 61. The fixed blade 62 includes the side wall 62b extending in the +Z direction from the end, at the −Y direction, of the fixed blade 62, and also includes a side wall 62c continuing to the side wall 62b. The side wall 62c extends along the Y-axis direction. The side wall 62c supports the paper-dust holding unit 56 provided between the fixed blade 62 and the side wall 62c in the Z-axis direction.

The side wall 62b extends in the Z-axis direction, and joins the fixed blade 62 and the side wall 62c. As illustrated in FIG. 3, the side wall 62b is disposed between the paper-dust holding unit 56 and the recording unit 40 in the Y-axis direction. The side wall 62b serves as one example of the wall portion WP configured to make the paper-dust holding unit 56 and the ejecting surface 42 of the recording unit 40 separated in the Y-axis direction. In addition, the fixed blade 62 and the side walls 62b and 62c cover the direction of the paper-dust holding unit 56 toward the recording unit 40. Thus, the fixed blade 62 and the side walls 62b and 62c are configured to separate the paper-dust holding unit 56 from the recording unit 40.

When the medium P is cut, the carriage 71 moves from a stand-by position provided outside of and at the +X direction side of the transport part T, toward the −X direction along the X-axis direction, in a state in which the medium P is disposed above the fixed blade 62. With this configuration, as the movable blade 61 moves along the X-axis direction toward the −X direction in a state of being in contact with the fixed blade 62, the medium P is cut. In other words, the movable blade 61 cuts the medium P in collaboration with the fixed blade 62.

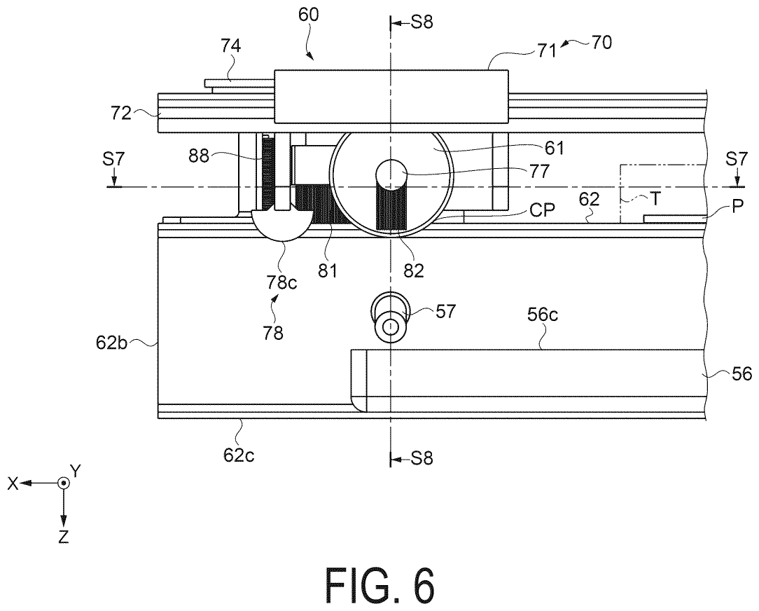

As illustrated from FIG. 4 to FIG. 8, the removing unit 81 is, for example, a brush, and is able to hold the removed paper dust. As illustrated in FIG. 6, the removing unit 81 is provided at the carriage 71 such that the top end of the brush is able to come into contact with the surface, at the −Z direction that is the upper surface, of the fixed blade 62. Thus, when the medium P is disposed between the fixed blade 62 and the removing unit 81, the brush of the removing unit 81 comes into contact with the surface, at the −Z direction that is the upper surface, of the medium P.

In addition, in the X-axis direction, the removing unit 81 is disposed more toward the +X direction than a cutting position CP at which the movable blade 61 cuts the medium P. In the present embodiment, the movable blade 61 has a surface disposed at the −Y direction side and coming into contact with the end, at the +Y direction, of the upper surface of the fixed blade 62, and the cutting position CP is a position on an outer edge, at the −X direction side, of this surface, as illustrated in FIGS. 6, 8, and 9. Note that the X-axis direction serves as one example of a cutting direction in which the movable blade 61 moves when the movable blade 61 cuts the medium P. In addition, the +X direction serves as one example of upstream in the cutting direction, and the −X direction serves as one example of downstream in the cutting direction.

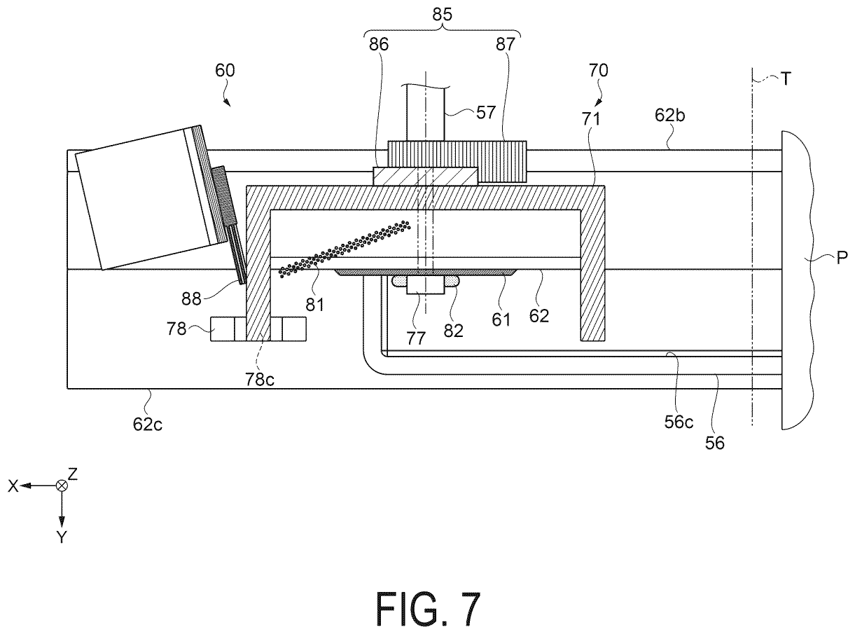

Furthermore, as illustrated in FIG. 7, an end, at the −X direction side, of the removing unit 81 is disposed more toward the −Y direction than the end, at the +X direction side, of the removing unit 81, and is disposed more toward the −Y direction than the movable blade 61. In addition, the end, at the +X direction side, of the removing unit 81 is more toward the +Y direction than the surface, at the −Y direction side, of the movable blade 61. That is, the end, at the +X direction side, of the removing unit 81 is disposed more toward the +Y direction than the cutting position CP at which the medium P is cut.

As illustrated from FIG. 6 to FIG. 8, the removing unit 82 is, for example, a brush, and is able to hold the removed paper dust. The removing unit 82 is provided at the end, at +Y direction side, of the shaft portion 77 so as to be able to come into contact with the surface, at the +Y direction side, of the movable blade 61. In addition, the removing unit 82 is provided at the shaft portion 77 such that the top end of the brush is able to come into contact with the surface, at the −Z direction side, of the medium P when the medium P is disposed at the vertically downward side of the removing unit 82. The shaft portion 77 is supported by the carriage 71 so as to be rotatable with the shaft center of the shaft portion 77 being the center of rotation. A toothed gear 86 is provided at the end, at the −Y direction side, of the shaft portion 77.

In addition, in the fixed blade 62, a rack 87 extending along the X-axis direction is provided at the outside of and the +X direction side of the transport path T and also at a meshing position with the toothed gear 86. The toothed gear 86 and the rack 87 constitute a rotating unit 85 configured to relatively rotate the removing unit 82 and the movable blade 61.

Note that, in the present embodiment, the position of the carriage 71 when a tooth disposed farthest to the −X direction of the teeth of the rack 87 meshes with the toothed gear 86 is set as a position disposed more toward the −X direction side than the stand-by position. In addition, in the present embodiment, when the carriage 71 is disposed at the stand-by position, the toothed gear 86 and the rack 87 mesh with each other. Furthermore, the position of the movable blade 61 when a tooth disposed farthest to the −X direction of the teeth of the rack 87 meshes with the toothed gear 86 is set as a position disposed more toward the +X direction than the transport path T.

For example, it is assumed that, after the carriage 71 moves in the −X direction from the stand-by position and the medium P is cut by the cutting unit 60, the carriage 71 is configured to move in the +X direction from the −X direction side of the transport path T toward the stand-by position. In this case, the toothed gear 86 and the rack 87 mesh with each other while the carriage 71 is moving in the +X direction toward the stand-by position.

Then, in a state in which the toothed gear 86 and the rack 87 mesh with each other, the carriage 71 keeps moving in the +X direction to cause the shaft portion 77 and the removing unit 82 to rotate with the shaft center of the shaft portion 77 being the center of rotation. With this configuration, the removing unit 82 rotates in a state of being in contact with the movable blade 61, thereby removing the paper dust attached on the movable blade 61 from the movable blade 61. The paper dust removed from the movable blade 61 is collected and held by the removing unit 82.

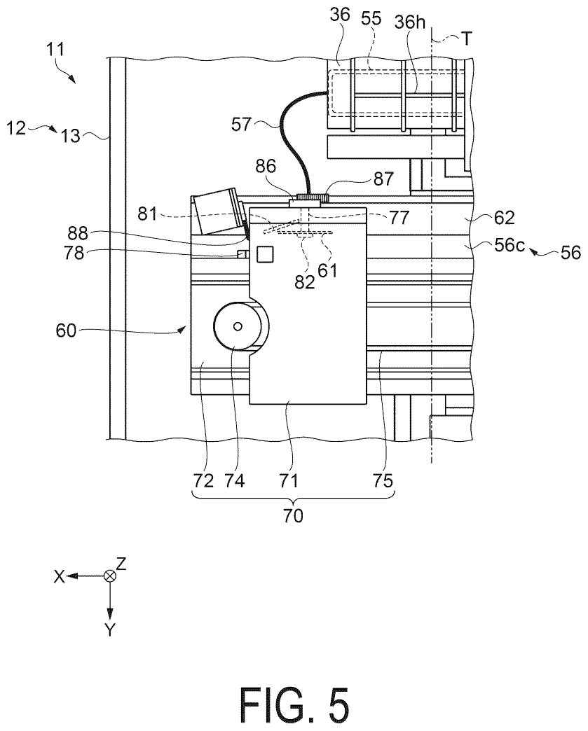

In addition, as illustrated from FIG. 5 to FIG. 7, in the fixed blade 62, a destaticizing unit 88 is provided at the outside of and the +X direction side of the transport path T. The destaticizing unit 88 is a so-called destaticizing brush, and the brush portion comes into contact with the carriage 71, thereby destaticizing the carriage 71, the movable blade 61, the shaft portion 77, the removing units 81 and 82, and the contact portion 78 provided in the carriage 71.

In the present embodiment, the removing units 81 and 82 are caused to temporarily hold the paper dust by using static electricity generated by friction between members. Thus, in the present embodiment, for example, while individual members that constitute the transport unit 33 are grounded, the removing units 81 and 82, the movable blade 61, the fixed blade 62, or the like of the cutting unit 60 are not grounded.

In the present embodiment, the medium P is paper such as a printing sheet, and the movable blade 61 and the brush serving as the removing unit 81 use a material positioned at the negative side of paper in the triboelectric series. In addition, the brush serving as the removing unit 82 uses a material positioned at the negative side of the material of the movable blade 61 in the triboelectric series. For example, the movable blade 61 is made of a steel material such as tool steel or stainless steel. In this case, the brushes of the removing units 81 and 82 use, for example, a material such as polypropylene, polyester, polyethylene, or polytetrafluoroethylene. Note that the fixed blade 62 is made of a steel material such as tool steel or stainless steel, as with the movable blade 61.

In addition, the carriage 71, the movable blade 61, the shaft portion 77, the removing units 81 and 82, and the contact portion 78 provided in the carriage 71 have electrical conductivity. For example, it may be possible to form the carriage 71 and the shaft portion 77 through casting using a metal material, or using an electrically conductive resin material. Furthermore, for example, the carriage 71, the shaft portion 77, the removing units 81 and 82, and the contact portion 78 may be made of a composite material obtained by adding an inorganic conductor such as carbon fiber to a resin material, or forming a thin membrane of a conductor on the surface to cause the composite material to have electrical conductivity. Note that at least a portion of the configuration described above may not have electrical conductivity.

In addition, for example, through an operation of cutting the medium P, the carriage 71 moves in the X-axis direction in a state in which the movable blade 61 and the removing units 81 and 82 are in contact with the medium P. In this case, the paper dust generated through cutting of the medium P by the cutting unit 60 is charged positively, and the movable blade 61 and the removing unit 81 are charged negatively. Thus, the paper dust generated through cutting of the medium P by the cutting unit 60 are pulled toward the movable blade 61 or the removing units 81 and 82, and are temporarily held there.

Furthermore, the paper dust attached on the surface, at the +Y direction side, of the movable blade 61 is removed by the removing unit 82, and is held by the removing unit 82. In addition, when the brush portion of the destaticizing unit 88 comes into contact with the carriage 71, the carriage 71 is destaticized, and the movable blade 61, the shaft portion 77, the removing units 81 and 82, and the contact portion 78 provided in the carriage 71 are also destaticized. This leads to a reduction in the holding force with which the movable blade 61 or the removing unit 82 holds the paper dust, for example.

The destaticizing unit 88 disposed at the fixed blade 62 is configured such that the brush portion of the destaticizing unit 88 comes into contact with the carriage 71 across a predetermined region in which the carriage 71 moves along the X-axis in a state in which the toothed gear 86 and the rack 87 mesh with each other. With this configuration, when the movable blade 61 is destaticized with the destaticizing unit 88, the removing unit 82 rotates relatively to the movable blade 61.

In other words, when the destaticizing unit 88 destaticizes the movable blade 61, the rotating unit 85 relatively rotates the removing unit 82 and the movable blade 61. With this configuration, the removing unit 82 removes the paper dust from the movable blade 61 having the reduced holding force with which the paper dust is held. In addition, the paper dust that the removing unit 82 temporarily holds drops in the +Z direction from the removing unit 82, and is collected by the paper-dust holding unit 56.

As illustrated from FIG. 5 to FIG. 9, the contact portion 78 is provided at the carriage 71 so as to be able to push a portion of the medium P toward the +Z direction, the portion being disposed more toward the +X direction side and toward the +Y direction side than the movable blade 61. The contact portion 78 has a thin plate shape extending from the carriage 71 toward the +Z direction. In the present embodiment, the contact portion 78 is formed integrally with the carriage 71. A tip portion 78c of the contact portion 78 that pushes, toward the +Z direction, the above-described portion of the medium P has a hemisphere shape as viewed from the Y-axis direction.

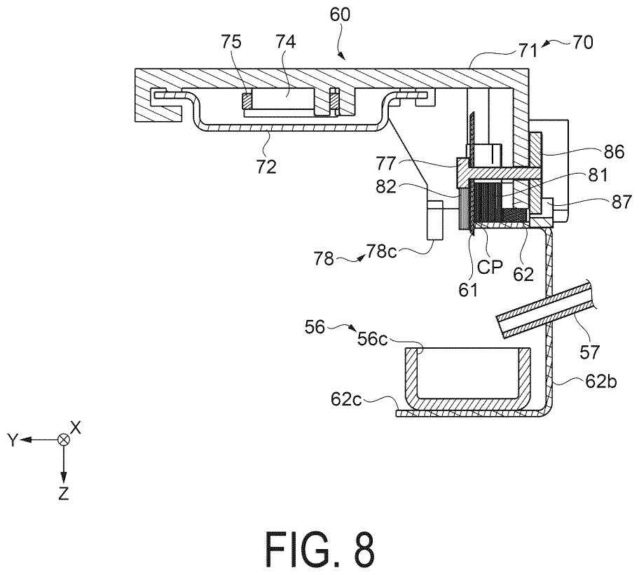

As illustrated in FIGS. 6 and 8, in the Z-axis direction, the end, at the +Z direction, of the tip portion 78c is disposed more toward the +Z direction than the surface, at the −Z direction side, of the fixed blade 62. In the present embodiment, in the Z-axis direction, the end, at the +Z direction, of the tip portion 78c is disposed more toward the +Z direction than the end, at the +Z direction, of the movable blade 61. In addition, in the present embodiment, in the X-axis direction, the end, at the +Z direction, of the tip portion 78c is disposed more toward the +X direction than the end, at the +X direction side, of the removing unit 81, as illustrated in FIGS. 6 and 7.

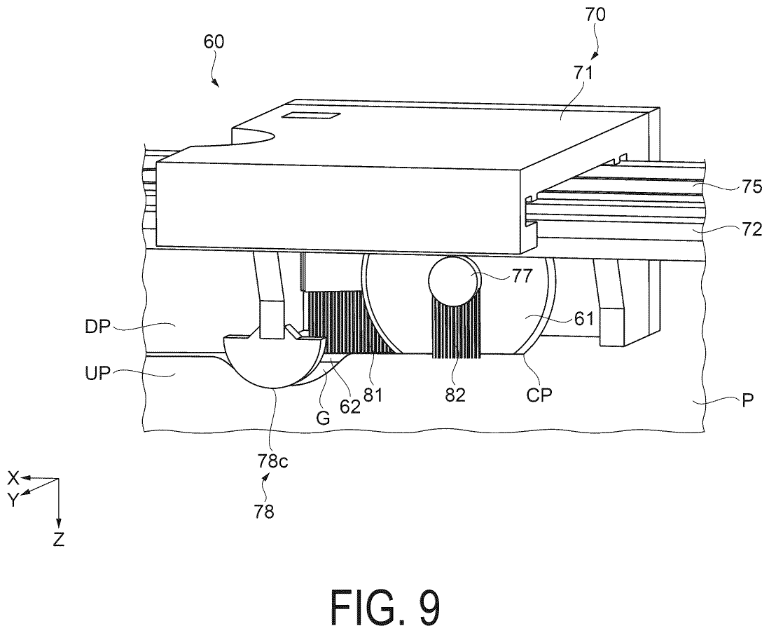

When the medium P is cut by the cutting unit 60 with the carriage 71 moving from the stand-by position in the −X direction, the contact portion 78 pushes, toward the +Z direction, a portion of the medium P that is disposed more toward the +X direction side and the +Y direction side than the movable blade 61. With this configuration, a space G is formed between a portion DP of the medium P and a portion UP of the medium P that are separated through cutting as illustrated in FIG. 9, the portion DP being disposed more toward the −Y direction side than the movable blade 61 and the portion UP being disposed more toward the +Y direction side than the movable blade 61.

As illustrated from FIG. 2 to FIG. 8, the paper-dust holding unit 56 is disposed at the +Z direction side of the cutting unit 60, and collects and holds the paper dust generated when the medium P is cut by the cutting unit 60. The paper-dust holding unit 56 has a shape of closed-bottom box having an opening 56c opened toward the −Z direction so as to be able to collect the paper dust. The opening 56c extends in the X-axis direction so as to correspond to the movement region of the movable blade 61 and the removing units 81 and 82 provided at the carriage 71.

In the Y-axis direction, the opening 56c of the paper-dust holding unit 56 supported by the side wall 62c is disposed at the end, at the +Y direction side, of the fixed blade 62 and at the vertically downward side of the movable blade 61. In other words, in the Y-axis direction, the paper-dust holding unit 56 and the opening 56c of the paper-dust holding unit 56 are disposed at the vertically downward side of a region lying between the removing unit 81 and the contact portion 78.

As illustrated in FIGS. 2 and 3, the discharging unit 45 transports, along the transport path T, the medium P on which recording is performed by the recording unit 40 and the medium P cut by the cutting unit 60, toward the mounting section 16 disposed at the +Y direction side of the recording unit 40. The discharging unit 45 includes a first discharging roller pair 46 and a second discharging roller pair 47.

The first discharging roller pair 46 is disposed at the +Y direction side of the recording unit 40 and the medium support portion 36 and also at the −Y direction side of the cutting unit 60. The first discharging roller pair 46 rotates in a state of nipping the medium P to transport, along the transport path T, the medium P toward the cutting unit 60 and the mounting section 16 disposed at the +Y direction side of the first discharging roller pair 46.

As illustrated in FIG. 3, the second discharging roller pair 47 is disposed at the +Y direction side of the cutting unit 60. In addition, the second discharging roller pair 47 is disposed at the −Y direction side of the opening 17 that is opened at the front face of the housing 13. As the first discharging roller pair 46 and the second discharging roller pair 47 that nip the medium P rotates, the discharging unit 45 sends the medium P toward the +Y direction.

The second discharging roller pair 47 supports the medium P cut by the cutting unit 60. Of the paper dust generated through cutting of the medium P, paper dust that has not been removed by the removing units 81 and 82 may possibly be attached on the surface, at the −Z direction side, of the cut medium P.

Individual members that constitute the discharging unit 45 of the present embodiment are grounded, as with the members that constitute the transport unit 33. In addition, the first discharging roller pair 46 and the second discharging roller pair 47 are comprised of a pair of rollers 48 and 49. The roller 49 coming into contact with the surface, at the −Z direction side, of the medium P is comprised of a toothed roller made of a steel material such as stainless steel. The roller 48 coming into contact with the surface, at the +Z direction side, of the medium P is comprised of a tubular shape roller made of a material having elasticity such as rubber.

In this case, the roller 49 coming into contact with the surface, at the −Z direction side, of the medium P has high electrical conductivity, and hence is easily grounded and is difficult to be charged, as compared with the roller 48 that comes into contact with the surface, at the +Z direction side, of the medium P. Thus, in particular, with the second discharging roller pair 47, it is easy to prevent the paper dust attached on the surface, at the −Z direction side, of the medium P from being attached on the roller 49. In addition, since the roller 49 coming into contact with the surface, at the −Z direction side, of the medium P is comprised of a toothed roller, it is possible to prevent ink from being transferred from the surface, at the −Z direction side, of the medium P for which recording is performed immediately before this.

The mounting section 16 receives the medium P transported by the discharging unit 45. As illustrated in FIG. 3, the mounting section 16 of the present embodiment is attached to the −Z direction side of the accommodation unit 15. As the mounting section 16 is attached to the accommodation unit 15, the mounting section 16 covers the opening, at the −Z direction side, of the accommodation unit 15. As the accommodation unit 15 is disposed at the supply position within the housing 13 through the opening 17, the mounting section 16 is disposed at a mounting position (see FIG. 3) at which the medium P is mounted on the mounting section 16. In other words, the mounting section 16 is detachably provided within the housing 13 so as to be integral with the accommodation unit 15.

When at the mounting position, the mounting section 16 is disposed at the +Z direction side that is the vertically downward side of the operation unit 14. In addition, when at the mounting position, the mounting section 16 is disposed between the operation unit 14 and the accommodation unit 15 in the Z-axis direction. Furthermore, when at the mounting position, the mounting section 16 is disposed at the +Z direction side that is the downward side of the cutting unit 60 and the removing units 81 and 82. In other words, when at the mounting position, the mounting section 16 overlaps with the movement region of the cutting unit 60 and the removing units 81 and 82 as viewed from the vertically upward side that is the −Z direction side.

Note that, in the mounting section 16, a support portion 16m configured to receive the medium P may be a flat surface extending in the X-axis direction and the Y-axis direction along the X-Y plane, or may be a plurality of protrusions extending in the Y-axis direction and disposed at intervals in the X-axis direction. In addition, for example, as illustrated in FIGS. 2 and 3, the support portion 16m may be configured such that the +Y direction side of the center thereof is comprised of a flat surface extending in the X-axis direction and the Y-axis direction, and the −Y direction side of the center thereof is comprised of a plurality of protrusions extending in the Y-axis direction.

In this case, the support portion 16m includes a recessed portion 16r formed at a portion comprised of the plurality of protrusions extending in the Y-axis direction and disposed at intervals in the X-axis direction. The recessed portion 16r is an indentation recessed in the +Z direction from the plurality of protrusions that receive the medium P. The recessed portion 16r is disposed at the vertically downward side of the movement region of the movable blade 61, the fixed blade 62, the movement region of the removing units 81 and 82, the paper-dust holding unit 56, and the second discharging roller pair 47. Thus, the mounting section 16 is able to receive, by using the recessed portion 16r, paper dust dropping outside of the paper-dust holding unit 56 from among the paper dust generated through cutting of the medium P.

The control unit 90 comprehensively controls drive of each mechanism in the recording device 11, and controls various types of operations performed in the recording device 11. The control unit 90 may be configured as a circuit including one or more processors configured to perform various types of processing in accordance with a computer program, or one or more hardware circuits configured to perform a portion of the various types of processing, or a combination of these processors or circuits. The hardware circuit is, for example, an application specific integrated circuit. The processor includes a CPU and a memory such as a RAM and a ROM, and the memory holds program codes or commands configured to cause the CPU to execute processing.

For example, the control unit 90 controls the feeding unit 31, the transport unit 33, the recording unit 40, and the discharging unit 45 to transport, toward the mounting section 16, the medium P on which recording is performed by the recording unit 40. In addition, for example, it is assumed to perform both-side recording in which recording is performed on the first surface S1 and the second surface S2 of the medium P. In this case, by controlling the transport unit 33 and the discharging unit 45, the control unit 90 causes the medium P on which recording is performed on the first surface S1 to be transported to a position at which the medium P is disposed at the +Y direction of the switching unit 38.

Then, by controlling the second discharging roller pair 47 and the switching units 38 and 39, the control unit 90 causes the medium P to be transported to the transport path T again through the inversion path R. Furthermore, by controlling the transport roller pair 35, the control unit 90 causes the medium P to be transported toward the medium support portion 36. With this configuration, the medium P transported along the transport path T is supported by the medium support portion 36 with the second surface S2 being a surface that faces the nozzles N. Then, the control unit 90 controls the recording unit 40 to perform recording on the second surface S2 of the medium P supported by the medium support portion 36. With this configuration, both-side recording is performed on the medium P.

In addition, the control unit 90 controls the moving unit 70 of the cutting unit 60 to cut the medium P. Furthermore, the control unit 90 controls the moving unit 70 of the cutting unit 60 to remove the paper dust generated when the medium P is cut by the cutting unit 60, by using the removing units 81 and 82. In addition, the control unit 90 controls the reading unit 21 to read an image or the like of the original document. Furthermore, the control unit 90 controls the operation unit 14 to cause the display unit of the operation unit 14 to display a message, thereby notifying a user of the state of the recording device 11.

As described above, with the recording device 11 according to the first embodiment, it is possible to obtain the following effects.

The recording device 11 includes the recording unit 40 configured to perform recording on the medium P transported from the −Y direction toward the +Y direction in the Y-axis direction, and also includes the cutting unit 60 configured to be able to cut the medium P on which recording is performed by the recording unit 40. In addition, the recording device 11 includes the discharging unit 45 configured to transport, in the +Y direction, the medium P on which recording is performed by the recording unit 40 and the medium P cut by the cutting unit 60. Furthermore, the recording device 11 includes the removing units 81 and 82 configured to remove the paper dust generated when the medium P is cut by the cutting unit 60. With this configuration, by removing the paper dust by the removing units 81 and 82, it is possible to reduce the possibility that the paper dust generated at the time of cutting the medium P causes a trouble of operation of the recording device 11. Note that it is only necessary that the recording device 11 includes at least either the removing unit 81 or 82.

The cutting unit 60 includes the movable blade 61 configured to cut the medium P, and the moving unit 70 configured to move the movable blade 61 in the X-axis direction intersecting the Y-axis direction. In addition, the removing units 81 and 82 are provided so as to be able to come into contact with the medium P, and are caused to move together with the movable blade 61 by the moving unit 70. With this configuration, since the removing units 81 and 82 move together with the movable blade 61, it is possible to quickly remove the paper dust generated through cutting of the medium P by the movable blade 61. In addition, since the removing units 81 and 82 are moved by the moving unit 70 of the cutting unit 60, it is possible to remove the paper dust throughout the entire width direction of the medium P with a simplified configuration.

In the X-axis direction, the removing unit 81 is disposed more toward the +X direction than the cutting position CP at which the movable blade 61 cuts the medium P. With this configuration, at the time of cutting the medium P by the cutting unit 60, the removing unit 81 is disposed upstream of the cutting position CP in the cutting direction. Thus, the paper dust generated at the time of cutting the medium P is more effectively removed.

The end, at the −X direction side, of the removing unit 81 is disposed more toward the −Y direction than the end, at the +X direction side, of the removing unit 81, and is disposed more toward the −Y direction than the movable blade 61. With this configuration, as the removing unit 81 moves toward the −X direction, it is possible to cause the removing unit 81 to remove the paper dust existing in a region of the medium P that is disposed more toward the −Y direction side than the movable blade 61, and also to gradually move the paper dust in the +Y direction that is a direction spaced away from the recording unit 40. Thus, in the recording unit 40, it is possible to prevent a trouble of the recording device 11 such as a deterioration in the recording accuracy due to the recording unit 40 in which the paper dust is attached on the ejecting surface 42, the paper dust enters the nozzles N, or the like.

The end, at the +X direction side, of the removing unit 81 is disposed more toward the +Y direction than the movable blade 61. With this configuration, as the removing unit 81 moves, it is possible to move the paper dust toward the +Y direction that is downstream of the movable blade 61 in the transport direction. This makes it possible to further suppress attaching of the paper dust on the recording unit 40.

The recording device 11 further includes the paper-dust holding unit 56 configured to hold the paper dust removed by the removing units 81 and 82. In addition, the moving unit 70 includes the contact portion 78 configured to push downward a portion of the medium P that is disposed more toward the +Y direction than the movable blade 61. Furthermore, in the Y-axis direction, the paper-dust holding unit 56 is disposed at the vertically downward side of a region between the removing unit 81 and the contact portion 78. With this configuration, due to the contact portion 78, the space G is formed between the portion UP of the medium P and the portion DP of the medium P that are separated through cutting. This makes it possible to easily drop, from the space G, the paper dust removed by the removing unit 81. In addition, the paper dust dropped from the space G is collected by the paper-dust holding unit 56.

The cutting unit 60 includes the fixed blade 62 configured to cut the medium P in collaboration with the movable blade 61. The fixed blade 62 extends in the X-axis direction. The removing unit 81 is able to come into contact with the fixed blade 62. With this configuration, the removing unit 81 comes into contact with the fixed blade 62 in a direct manner or through the medium P, which makes it possible to more reliably remove the paper dust.

The cutting unit 60 includes the movable blade 61 configured to cut the medium P, the shaft portion 77 configured to support the movable blade 61, and the moving unit 70 configured to move the movable blade 61 in the X-axis direction intersecting the Y-axis direction. In addition, the removing unit 82 is provided at the shaft portion 77, and is able to come into contact with the movable blade 61. Furthermore, the removing unit 82 and the movable blade 61 are rotatable relatively to each other. With this configuration, it is possible to remove, with the removing unit 82, the paper dust attached on the movable blade 61. This makes it possible to maintain the sharpness of the movable blade 61, and to maintain the cutting accuracy of the movable blade 61. In addition, as the the sharpness of the movable blade 61 can be maintain, this makes it possible to suppress an increase in the amount of paper dust generated through cutting of the medium P.

The removing unit 82 is able to come into contact with the surface, at the +Y direction side, of the movable blade 61. With this configuration, the removing unit 82 is able to remove the paper dust attached on the surface, at the +Y direction side, of the movable blade 61 that is opposite from the −Y direction side where the recording unit 40 is disposed.

The removing unit 82 holds the removed paper dust. This configuration makes it possible to reduce the possibility that the removed paper dust is attached on the recording unit 40.

The recording device 11 further includes the rotating unit 85 configured to rotate the removing unit 82 and the movable blade 61 relatively to each other. With this configuration, since the removing unit 82 rotates relatively to the movable blade 61, it is possible to effectively remove the paper dust attached on the movable blade 61.

The recording device 11 further includes the destaticizing unit 88 configured to destaticize the movable blade 61, and when the destaticizing unit 88 is destaticizing the movable blade 61, the rotating unit 85 rotates the removing unit 82 and the movable blade 61 relatively to each other. With this configuration, since the removing unit 82 and the movable blade 61 are rotated relatively to each other while the movable blade 61 is being destaticized, it is possible to easily remove the paper dust from the movable blade 61.

The recording device 11 further includes the housing 13 configured to accommodate the recording unit 40 and the cutting unit 60, and also includes the accommodation unit 15 configured to accommodate the medium P on which recording is performed by the recording unit 40, and the accommodation unit 15 is detachable with respect to the inside of the housing 13. In addition, the removing units 81 and 82 overlap with the accommodation unit 15 as viewed from the vertically upward side. With this configuration, even when the paper dust removed by the removing units 81 and 82 drops, the paper dust drops in a direction toward the accommodation unit 15. Thus, by detaching the accommodation unit 15 from the housing 13, it is possible to remove the paper dust from the inside of the housing 13.

The recording device 11 includes the housing 13 configured to accommodate the recording unit 40 and the cutting unit 60, and also includes the accommodation unit 15 configured to accommodate the medium P on which recording is performed by the recording unit 40. In addition, the recording device 11 further includes the mounting section 16 that is provided at the −Z direction of the accommodation unit 15 and on which the medium P on which recording is performed by the recording unit 40 is mounted. In addition, the accommodation unit 15 and the mounting section 16 are detachably provided within the housing 13 so as to be integral with each other, and the removing units 81 and 82 overlap with the mounting section 16 as viewed from the vertically upward side. With this configuration, even when the paper dust removed by the removing units 81 and 82 drops, the paper dust drops in a direction toward the mounting section 16. Thus, by detaching the accommodation unit 15 from the housing 13, it is possible to remove the paper dust collected in the mounting section 16 from the inside of the housing 13.

The recording device 11 includes the paper-dust holding unit 56 disposed at the +Z direction of the cutting unit 60, and configured to hold the paper dust generated when the medium P is cut by the cutting unit 60. In addition, the recording device 11 further includes the wall portion WP configured to make the paper-dust holding unit 56 and the recording unit 40 separated in the Y-axis direction. With this configuration, it is possible to reduce the possibility that the paper dust held by the paper-dust holding unit 56 spreads, and is attached to the recording unit 40.

The recording device 11 includes the recording unit 40 configured to perform recording on the medium P transported from the −Y direction toward the +Y direction in the Y-axis direction, and also includes the cutting unit 60 configured to cut the medium P on which recording is performed by the recording unit 40. Furthermore, the recording device 11 includes the discharging unit 45 configured to transport, in the +Y direction, the medium P on which recording is performed by the recording unit 40 and the medium P cut by the cutting unit 60. In addition, the recording device 11 includes the paper-dust holding unit 56 disposed at the +Z direction of the cutting unit 60 and configured to hold the paper dust generated when the medium P is cut by the cutting unit 60. With this configuration, by collecting the paper dust in the paper-dust holding unit 56, it is possible to reduce the possibility that the paper dust within the housing 13 causes a trouble of operation of the recording device 11. Note that, in a case of such a configuration, the recording device 11 may not include the removing unit 81 or 82.

The recording device 11 further includes the wall portion WP configured to make the paper-dust holding unit 56 and the recording unit 40 separated in the Y-axis direction. With this configuration, in a state in which the paper dust is collected in the paper-dust holding unit 56, separation is made such that the recording unit 40 is disposed at the −Y direction side of the wall portion WP, and the paper-dust holding unit 56 is disposed at the +Y direction side of the wall portion WP. This makes it possible to reduce the possibility that the paper dust is attached to the recording unit 40.

The recording device 11 includes the waste-liquid collection section 55 configured to collect, as a waste liquid, ink ejected outside of the medium P from the recording unit 40 configured to perform recording by ejecting the ink to the medium P. In addition, the recording device 11 further includes the flow-in section 57 configured to cause the waste liquid collected in the waste-liquid collection section 55 to flow into the paper-dust holding unit 56. With this configuration, by causing the waste liquid to flow into the paper-dust holding unit 56, it is possible to prevent the paper dust from spreading from the paper-dust holding unit 56 without adding any additional configuration.

The cutting unit 60 includes the movable blade 61 configured to cut the medium P, and the fixed blade 62 configured to cut the medium P in collaboration with the movable blade 61. The fixed blade 62 extends in the X-axis direction intersecting the Y-axis direction, and the paper-dust holding unit 56 is supported by the fixed blade 62. With this configuration, the positional accuracy of the paper-dust holding unit 56 relative to the cutting unit 60 improves. This enables the paper-dust holding unit 56 to more reliably collect the paper dust.

The recording device 11 according to the above-described embodiments of the present disclosure is basically assumed to have the configuration as described above. However, it goes without saying that modification, omission, and the like of part of the configuration are possible as long as such modification, omission, and the like do not deviate from the main points of the present disclosure. In addition, the embodiment described above and other embodiments described below can be carried out in combination with one another within a technically consistent range. Below, other embodiments will be described.

In the embodiment described above, the cutting unit 60 may not include the fixed blade 62. Furthermore, the movable blade 61 may not be the circular blade. In this case, the movable blade 61 may be a flat blade having a sharp portion.

The embodiment described above may employ a configuration in which the carriage 71 including the movable blade 61 moves in the +X direction, whereby the cutting unit 60 cuts the medium P. In this case, the stand-by position of the carriage 71 is disposed outside of and at the −X direction side of the transport path T. In addition, in this case, the carriage motor 76 may be disposed at the +X direction side of the transport path T. In addition, in this case, the removing unit 81 is disposed more toward the −X direction than the cutting position CP at which the movable blade 61 cuts the medium P. In addition, in this case, the end, at the +X direction side, of the removing unit 81 is disposed more toward the −Y direction than the end, at the −X direction side, of the removing unit 81 and more toward the −Y direction than the movable blade 61. In addition, in this case, the end, at the −X direction side, of the removing unit 81 is disposed more toward the +Y direction than the surface, at the −Y direction side, of the movable blade 61.

The embodiment described above may employ a configuration in which the carriage 71 including the movable blade 61 is caused to reciprocate to the −X direction and the +X direction, whereby the cutting unit 60 cuts the medium P. In this case, the removing unit 81 may be disposed either at the +X direction side or at the −X direction side of the cutting position CP at which the movable blade 61 cuts the medium P. Alternatively, in this case, the removing unit 81 may be disposed both at the +X direction side and at the −X direction side of the cutting position CP.

The embodiment described above may employ a configuration in which the control unit 90 controls the moving unit 70 of the cutting unit 60 to cause the brush portion of the destaticizing unit 88 to repeatedly come into contact with the carriage 71. For example, the control unit 90 causes the carriage 71 to reciprocate in the X-axis direction in a region that exists outside of the transport path T in the X-axis direction to repeat contacting and departing between the brush portion of the destaticizing unit 88 and the carriage 71. With this configuration, the control unit 90 may facilitate destaticizing of the carriage 71, the movable blade 61 provided in the carriage 71, the shaft portion 77, the removing units 81 and 82, and the contact portion 78.

The embodiment described above may employ a configuration in which the paper-dust holding unit 56 is not provided across the region between the end, at the −Y direction, of the removing unit 81 and the contact portion 78 in the Y-axis direction. For example, the paper-dust holding unit 56 may be provided at a position that overlaps with at least a portion of a region between the contact portion 78 and the end, at the −Y direction, of the removing unit 81 in the Y-axis direction as viewed from the vertically upward side.

The embodiment described above may employ a configuration in which the opening 56c of the paper-dust holding unit 56 does not extend in the X-axis direction so as to correspond to the movement region of the movable blade 61 and the removing units 81 and 82 provided at the carriage 71. For example, the opening 56c may be provided so as to correspond to a section of the movement region of the movable blade 61 and the removing units 81 and 82 toward the X-axis direction, the section being a section in which the brush portion of the destaticizing unit 88 is in contact with the carriage 71.

The embodiment described above may employ a configuration in which the recording device 11 may not include the paper-dust holding unit 56.

The embodiment described above may employ a configuration in which the movable blade 61 is fixed so as not to rotate relatively to the shaft portion 77. In this case, the removing unit 82 may be provided at the shaft portion 77 so as to be rotatable with the shaft portion 77 being the center of rotation, whereby the movable blade 61 and the removing unit 82 relatively rotate.

The embodiment described above may employ a configuration in which, in addition to the configuration in which the shaft portion 77 and the removing unit 82 rotate with the shaft portion 77 being the center of rotation, the movable blade 61 rotates relatively to the shaft portion 77, whereby the movable blade 61 and the removing unit 82 relatively rotate.

The embodiment described above may employ a configuration in which the rotating unit 85 is not comprised of the toothed gear 86 and the rack 87. For example, the recording device 11 may include a drive mechanism and a drive motor that serve as the rotating unit 85 and rotate the movable blade 61 separately from the shaft portion 77. In this case, the control unit 90 controls drive of the drive motor. With this configuration, the control unit 90 may cause the movable blade 61 to rotate while the carriage 71 is moving over the movement region of the carriage 71 toward the X-axis direction. Furthermore, for example, the control unit 90 may cause the movable blade 61 to rotate when the carriage 71 is disposed at the stand-by position.

The embodiment described above may employ a configuration in which the movable blade 61 rotates due to sliding relative to the fixed blade 62 or the medium P in association with movement of the carriage 71 in the X-axis direction, whereby the movable blade 61 and the removing unit 82 relatively rotate. In this case, the rotating unit 85 may not be provided.

The embodiment described above may employ a configuration in which the brush portion of the destaticizing unit 88 is disposed so as to extend in the X-axis direction along the movement region in which the carriage 71 moves. With this configuration, the brush portion of the destaticizing unit 88 may always be in contact with the carriage 71 in the movement region in which the carriage 71 moves along the X-axis.

The embodiment described above may employ a configuration in which the recording device 11 may include a charging unit configured to electrically charge the movable blade 61 of the cutting unit 60. With this configuration, it may be possible to cause more paper dust generated when the medium P is cut by the cutting unit 60 to be attached to the movable blade 61, thereby removing, by the removing unit 82, the paper dust attached to the movable blade 61.

The embodiment described above may employ a configuration in which the removing units 81 and 82 are not caused to temporarily hold the paper dust by using static electricity generated by friction between members. In this case, the cutting unit 60 may be grounded. In addition, in this case, the brush serving as the removing unit 81 may use a material ranked at the positive side of paper in the triboelectric series. In addition, in this case, the brush serving as the removing unit 82 may use a material ranked at the positive side of the material of the movable blade 61 in the triboelectric series.

The embodiment described above may employ a configuration in which the removing units 81 and 82 are not caused to temporarily hold the paper dust by using static electricity generated by friction between members. In this case, the removing unit 82 may be a destaticizing brush. In addition, in this case, the removing unit 81 may be a destaticizing brush. In addition, in this case, the recording device 11 may not include the destaticizing unit 88.

The embodiment described above may employ a configuration in which the ends, at the +Y direction side, of the switching unit 38 and the inversion path member 37 are disposed between the second discharging roller pair 47 and the movable blade 61 of the cutting unit 60 in the Y-axis direction. In this case, the inversion path member 37 extends in the Y-axis direction through the paper-dust holding unit 56, the fixed blade 62, the side walls 62b and 62c, the medium support portion 36, and the +Z direction side of the waste-liquid collection section 55. In addition, in this case, the flow-in section 57 may cause the waste liquid collected by the waste-liquid collection section 55 to flow into the paper-dust holding unit 56 through the vertically upward side of the inversion path member 37. In addition, in this case, the flow-in section 57 may be coupled to the center, in the X-axis direction, of the waste-liquid collection section 55. In addition, in this case, the position at which the waste liquid from the flow-in section 57 is discharged toward the paper-dust holding unit 56 may be at the vertically upward side of the opening 56c and also at the center, in the X-axis direction, of the paper-dust holding unit 56. In addition, in this case, the flow-in section 57 may have a gutter shape of which −Z direction side is opened.

The embodiment described above may employ a configuration in which the recording device 11 does not include the flow-in section 57. In this case, the waste-liquid collection section 55 and the paper-dust holding unit 56 may be provided in the middle of the waste-liquid tube 54. In addition, ink serving as the waste liquid received by the waste-liquid receiving section 52 may pass through the waste-liquid collection section 55 and the paper-dust holding unit 56 to be collected in the waste-liquid tank 53.

In the embodiment described above, the recording device 11 may be a so-called laser printer configured to cause toner to be attached on the medium P to perform recording. In this case, the recording device 11 may not include the waste-liquid collection section 55.

What is claimed is:

1. A recording device comprising:
a recording unit configured to perform recording on a medium transported from upstream toward downstream in a transport direction;
a cutting unit configured to cut the medium on which recording is performed by the recording unit; and
a removing unit configured to remove paper dust generated when the medium is cut by the cutting unit.

2. The recording device according to claim 1, wherein
the cutting unit includes:
a movable blade configured to cut the medium; and
a moving unit configured to move the movable blade in a width direction intersecting the transport direction,
the removing unit is configured to come into contact with the medium, and
the removing unit together with the movable blade is moved by the moving unit.

3. The recording device according to claim 2, wherein
in a cutting direction in which the movable blade moves when the movable blade cuts the medium, the removing unit is disposed upstream of a cutting position at which the movable blade cuts the medium.

4. The recording device according to claim 3, wherein
a downstream end, in the cutting direction, of the removing unit is disposed more upstream in the transport direction than an upstream end, in the cutting direction, of the removing unit, and is disposed upstream in the transport direction of the movable blade.

5. The recording device according to claim 4, wherein
the upstream end, in the cutting direction, of the removing unit is disposed downstream in the transport direction of the movable blade.

6. The recording device according to claim 2 further comprising:
a paper-dust holding unit configured to hold the paper dust removed by the removing unit, wherein
the moving unit includes a contact portion configured to push downward a portion of the medium that is disposed downstream in the transport direction of the movable blade, and
in the transport direction, the paper-dust holding unit is disposed at a vertically downward side of a region between the removing unit and the contact portion.

7. The recording device according to claim 2, wherein
the cutting unit includes a fixed blade configured to cut the medium in collaboration with the movable blade,
the fixed blade extends in the width direction, and
the removing unit is configured to come into contact with the fixed blade.

8. The recording device according to claim 1, wherein
the cutting unit includes:
a movable blade configured to cut the medium;
a shaft portion configured to support the movable blade; and
a moving unit configured to move the movable blade in a width direction intersecting the transport direction,
the removing unit is provided at the shaft portion,
the removing unit is configured to come into contact with the movable blade, and
the removing unit is configured to rotate relatively to the movable blade.

9. The recording device according to claim 8, wherein the removing unit is configured to come into contact with a surface, at the downstream in the transport direction, of the movable blade.

10. The recording device according to claim 8, wherein the removing unit is configured to hold the removed paper dust.

11. The recording device according to claim 8 further comprising: a rotating unit configured to rotate the removing unit and the movable blade relatively to each other.

12. The recording device according to claim 11 further comprising:
a destaticizing unit configured to destaticize the movable blade, wherein
when the destaticizing unit destaticizes the movable blade, the rotating unit rotates the removing unit and the movable blade relatively to each other.

13. The recording device according to claim 2 further comprising:
a housing configured to accommodate the recording unit and the cutting unit; and
an accommodation unit configured to accommodate the medium on which recording is performed by the recording unit, wherein
the accommodation unit is detachable relative to an inside of the housing, and
the removing unit overlaps with the accommodation unit when viewed from a vertically upward side.

14. The recording device according to claim 2 further comprising:
a housing configured to accommodate the recording unit and the cutting unit;
an accommodation unit configured to accommodate the medium on which recording is performed by the recording unit; and
a mounting section on which the medium on which recording is performed by the recording unit is mounted, the mounting section being provided at an upper side of the accommodation unit, wherein
the accommodation unit and the mounting section are integrally detachable relative to an inside of the housing, and
the removing unit overlaps with the mounting section when viewed from a vertically upward side.

15. The recording device according to claim 2 further comprising:
a paper-dust holding unit disposed below the cutting unit and configured to hold the paper dust generated when the medium is cut by the cutting unit; and
a wall portion configured to make the paper-dust holding unit and the recording unit separated in the transport direction.

16. A recording device comprising:
a recording unit configured to perform recording on a medium transported from upstream toward downstream in a transport direction;
a cutting unit configured to cut the medium on which recording is performed by the recording unit;
a discharging unit configured to transport, to the downstream, the medium on which recording is performed by the recording unit and the medium cut by the cutting unit; and
a paper-dust holding unit disposed below the cutting unit and configured to hold paper dust generated when the medium is cut by the cutting unit.

17. The recording device according to claim 16 further comprising: a wall portion configured to make the paper-dust holding unit and the recording unit separated in the transport direction.

18. The recording device according to claim 16 further comprising:
a waste-liquid collection section configured to collect, as a waste liquid, a liquid ejected from the recording unit to outside of the medium, the recording unit being configured to perform recording by ejecting the liquid to the medium; and
a flow-in section configured to cause the waste liquid collected in the waste-liquid collection section to flow into the paper-dust holding unit.

19. The recording device according to claim 16, wherein
the cutting unit includes:
a movable blade configured to cut the medium; and
a fixed blade configured to cut the medium in collaboration with the movable blade,
the fixed blade extends in a width direction intersecting the transport direction, and
the paper-dust holding unit is supported by the fixed blade.
